(19) United States
(12) Patent Application Publication
(10) Pub. No.: US 2009/0158753 A1
(43) Pub. Date: Jun. 25, 2009

(54) GAS SAFETY DEVICE AND THE CONTROL METHOD OF HEATING VENTILATING AND AIR CONDITIONING SYSTEM

(76) Inventor: Deok-Jae Lee, Uijeongbu-si (KR)

Correspondence Address: BIRCH STEWART KOLASCH & BIRCH, PO BOX 747, FALLS CHURCH, VA, 22040-0747, US

(21) Appl. No.: 12/295,571

(22) PCT Filed: Mar. 30, 2007
(86) PCT No.: PCT/KR07/01555

§ 371 Date: Sep. 30, 2008

(30) Foreign Application Priority Data
Mar. 30, 2006 (KR) 10-2006-0028795

(51) Int. Cl. F25D 3/00; F25D 29/00; B60H 1/32

(52) U.S. Cl. 62/56; 62/163; 62/239

(57) ABSTRACT

Disclosed is a gas safety device of a heating, ventilating, and air conditioning system for vehicles. The gas safety device includes a gas sensor installed at an air inlet connecting an engine room and the inside of a vehicle; and refrigerant cutoff valves installed at lines of an evaporator at the sides of refrigerant inlet or outlet for restricting the flow of a refrigerant by means of the operation of a control unit according to a sensing signal value of the gas sensor. In the gas safety device, when gas is leaked in the engine room after a starting switch of the vehicle is turned on, the gas sensor installed at the air inlet connecting the engine room and the inside of the vehicle senses the gas leakage, and outputs a corresponding signal value to the control unit. Then, the control unit determines whether or not gas is leaked through the signal value, and operates the refrigerant cutoff valve installed at the line of the evaporator at the side of the refrigerant inlet, thus controlling the flow of the refrigerant.

### TECHNICAL FIELD

The present invention relates to a gas safety device of a heating, ventilating, and air conditioning system for vehicles, and more particularly to a gas safety device of a heating, ventilating, and air conditioning system for vehicles, which senses gas leaked from an evaporator of a vehicle and cuts off the gas leakage so as to safely protect passengers in the vehicle.

### BACKGROUND ART

In general, heating, ventilating, and air conditioning (hereinafter, referred to as “HVAC”) systems for vehicles are applied to a vehicle so as to allow passengers in the vehicle to enjoy a drive in a comfortable state through cooling or heating. Techniques of HVAC systems had been rapidly developed, and an HVAC system, which is controlled by itself without a driver's separate manipulation and adjusts an indoor temperature to a setting value according to a variation of external heat, has been developed now.

Such a HVAC system is an apparatus for controlling indoor air in a vehicle. Specifically, in a cooling mode, a refrigerant is compressed by a power generating apparatus of the vehicle, is condensed by external air to be rapidly expanded, and is evaporated, and when the refrigerant is evaporated, the refrigerant robs the external air of heat, thereby cooling the external air. That is, air is blown to the surface of an evaporator, and thus cool air is produced using heat-exchange. Further, in a heating mode, air is blown to the surface of a heater using heat obtained by burning a fuel in the power generating apparatus and cooling water heated by an engine, and thus hot air is produced.

Here, a microprocessor computer controls the HVAC system through sensors for sensing an indoor temperature, an outdoor air temperature, a quantity of solar radiation, and a cooling water temperature.

Hereinafter, the structure and function of a refrigerating cycle of the above-described HVAC system will be described in more detail.

A compressor compresses a refrigerant into a high-temperature and high-pressure gas state and transfers the compressed refrigerant to a condenser, and the condenser condenses the refrigerant in the high-temperature and high-pressure gas state, transferred from the compressor, by external air and transfers the condensed refrigerant to an expansion valve.

The compressor inhales a cold refrigerant, which is changed to a gas state by an evaporator, compresses the refrigerant into a high-temperature and high-pressure gas state, and transfers the compressed refrigerant to the condenser. The reason why the refrigerant is compressed is that the refrigerant in the gas state can be liquefied at a high temperature.

A refrigerant, which is used in general vehicles, is liquefied at a temperature of −29.8° C. under the usual atmospheric pressure of 1 atm. In order to liquefy the refrigerant, which is changed into a gas state by absorbing heat from the evaporator, again, the refrigerant must be decreased to a temperature of −29.8° C. However, such a low temperature cannot be substantially achieved in vehicles. Thus, in order to liquefy the refrigerant at a comparatively high temperature in an engine room, the refrigerant is compressed. Further, the compressor inhales gas in a low-pressure state from the evaporator, and discharges gas in a high-pressure state to the condenser, thus serving to circulating the refrigerant.

The condenser is located at the foremost portion of the engine room of a vehicle, and cools the refrigerant in the high-temperature and high-pressure gas state transferred from the compressor so as to be changed into a liquid state. As the refrigerant in the high-temperature and high-pressure gas state passes through the condenser, the refrigerant contacts the air and discharges heat to the outside, thus being changed into a middle-temperature and high-pressure liquid state.

The refrigerant, which is changed into the liquid state by the condenser, does not form a complete liquid state, but forms a gas-liquid mixed state. Thus, a dryer separates the refrigerant into a part in a liquid state and a part in a gas state, and transfers only the part of the refrigerant in the liquid state to the evaporator through the expansion valve.

As described above, the refrigerating cycle of vehicles cools air using a principle that a material absorbs or emits heat when the phase of the material is changed.

Various refrigerants may be applied to the above refrigerating cycle. The most necessary characteristic of refrigerants is that the refrigerants are easily condensed, i.e., liquefied, at a comparatively low temperature. In order to be applied to the refrigerating cycle of vehicles, the refrigerants satisfy the requirements, such as properly low boiling point, high evaporation latent heat, properly low condensation pressure, small specific volume of vapor, low temperature of exposed gas of a compressor, sufficiently high critical temperature, low corrosiveness, high safety, excellent electric insulation, easy leak detection, non-induction of environmental pollution due to leakage, low inflammability and explosiveness, innoxiousness to the human body, non-generating of offensive odors, low viscosity (the hither the viscosity of a refrigerant is, the higher the boiling point of the refrigerant is), and excellent thermal conductivity. However, a refrigerant, which completely satisfies the above requirements, is not yet found.

### DISCLOSURE OF INVENTION

### Technical Problem

Therefore, the present invention has been made in view of the above problems and it is an object of the present invention to provide a gas safety device of a heating, ventilating, and air conditioning system for vehicles, which senses a refrigerant leaked from an evaporator of a vehicle and controls the flow of the refrigerant even though either a combustible refrigerant or a non-combustible refrigerant is used as the refrigerant in a gas state.

### Technical Solution

In accordance with an aspect of the present invention, the above and other objects can be accomplished by the provision of a gas safety device of a heating, ventilating, and air conditioning system for vehicles, comprising a gas sensor installed at an air inlet connecting an engine room and the inside of a vehicle; and refrigerant cutoff valves installed at lines of an evaporator at the sides of refrigerant inlet or outlet for restricting the flow of a refrigerant by means of the operation of a control unit according to a sensing signal value of the gas sensor.

In accordance with another aspect of the present invention, there is provided a gas safety device of a heating, ventilating, and air conditioning system for vehicles, comprising: a gas sensor installed at an air inlet connecting an engine room and the inside of a vehicle; a shock sensor installed in the vehicle; and refrigerant cutoff valves installed at lines at the sides of refrigerant inlet or outlet of an evaporator for restricting the flow of a refrigerant by means of the operation of a control unit according to either of sensing signal values of the gas sensor and the shock sensor.

Preferably, the gas safety device further comprises either of an alarming unit for giving a gas leakage alarm in the vehicle and a display unit for displaying a gas leakage state so that passengers in the vehicle can verify the sensing signal value of the gas sensor provided at the air inlet.

Further, the gas sensor may employ a sensor for sensing R-152a, which is one of combustible refrigerants.

In the gas safety device of the present invention, when either of sensing signal values of the gas sensor installed at the air inlet connecting the engine room and the inside of the vehicle and the shock sensor installed in the vehicle is input to the control unit, the control unit operates the refrigerant cutoff valve installed at the line at the side of the refrigerant inlet of the evaporator to restrict the flow of the refrigerant.

### ADVANTAGEOUS EFFECTS

The present invention provides a gas safety device of a heating, ventilating, and air conditioning system for vehicles, in which when a signal value from either a gas sensor installed at an air inlet connecting an engine room and the inside of a vehicle or a shock sensor installed in the vehicle is input to a control unit, the control unit determines whether or not gas is leaked through the input signal value, selectively operates a refrigerant cutoff valve installed at a line of an evaporator at the side of a refrigerant inlet, and thus controls the flow of a refrigerant. Thereby, in case that a combustible refrigerant gas is used, it is possible to prevent a gas explosion.

When the gas is leaked, the gas sensor senses the gas leakage, and an alarm unit or a display unit informs the gas leakage of a driver or passengers, thereby preventing an accident caused by the gas leakage.

Since the gas leakage is sensed or the gas flow is restricted, a combustible gas, which was not conventionally used due to danger of an explosion, can be used as the refrigerant.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram illustrating a gas safety device of a heating, ventilating, and air conditioning system for vehicles in accordance with a first embodiment of the present invention; and

FIG. 2 is a circuit diagram illustrating a gas safety device of a heating, ventilating, and air conditioning system for vehicles in accordance with a second embodiment of the present invention.

### BEST MODE FOR CARRYING OUT THE INVENTION

Now, preferred embodiments of the present invention will be described in detail with reference to the annexed drawings.

### First Embodiment

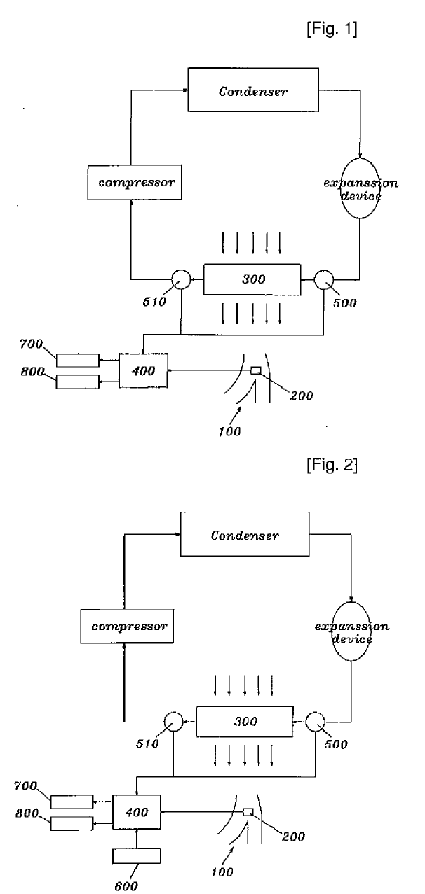

As shown in FIG. 1, a gas safety device of a heating, ventilating, and air conditioning system for vehicles in accordance with a first embodiment of the present invention includes a gas sensor 200, which is installed at an air inlet 100 connecting an engine room and the inside of a vehicle and senses a gas leakage, and refrigerant cutoff valves 500 and 510, which are installed at lines of an evaporator 300 at the sides of refrigerant inlet and outlet and restrict the flow of a refrigerant according to a signal value through a control unit 400.

The gas sensor 200 is installed in a passage of the air inlet 100 connecting the engine room and the inside of the vehicle, senses gas flowing in together with air, and outputs a corresponding signal value to the control unit 400.

The gas sensor 200 contains a combustible refrigerant or a non-combustible refrigerant, which is used as a refrigerant gas for vehicles. Here, R-152a may be used as the combustible refrigerant.

The refrigerant cutoff valves 500 and 510 are respectively installed at the lines of the evaporator 300 at the sides of the refrigerant inlet and outlet, i.e., the lines of the evaporator 300 connected to an expansion valve and a compressor, and cut off the flow of the refrigerant according to the signal value of the control unit 400. That is, the refrigerant cutoff valves 500 and 510 have a structure such that a disk in a body is rotated according to the input signal value to close a path, and employ a well-known manual or automatic type valve.

In the above-described gas safety device of a heating, ventilating, and air conditioning system for vehicles, when gas is leaked in the engine room after a starting switch of the vehicle is turned on, the gas sensor 200 installed at the air inlet 100 connecting the engine room and the inside of the vehicle senses the gas leakage, and outputs a corresponding signal value to the control unit 400. Then, the control unit 400 determines whether or not gas is leaked through the signal value, and selectively operates the refrigerant cutoff valves 500 and 510 installed at the lines of the evaporator 300 at the sides of the refrigerant inlet and outlet, thus controlling the flow of the refrigerant.

The gas safety device may further include an alarming unit 700 for giving a gas leakage alarm in the vehicle or a display unit 800 for displaying a gas leakage state so that passengers in the vehicle can verify the signal value of the gas sensor 200.

### Second Embodiment

As shown in FIG. 2, a gas safety device of a heating, ventilating, and air conditioning system for vehicles in accordance with a second embodiment of the present invention includes a gas sensor 200, which is installed at an air inlet 100 connecting an engine room and the inside of a vehicle and senses a gas leakage, a shock sensor 600, which is installed in the vehicle and senses a shock when the shock is applied to the vehicle, and refrigerant cutoff valves 500 and 510, which are installed at lines of an evaporator 300 at the sides of refrigerant inlet and outlet and restrict the flow of a refrigerant according to a signal value through a control unit 400.

The gas sensor 200 is installed in a passage of the air inlet 100 connecting the engine room and the inside of the vehicle, senses gas flowing in together with air, and outputs a corresponding signal value to the control unit 400.

The gas sensor 200 contains a combustible refrigerant or a non-combustible refrigerant, which is used as a refrigerant gas for vehicles. Here, R-152a may be used as the combustible refrigerant.

Well-known shock sensors for sensing a shock applied to a vehicle are used as the shock sensor 600. For example, the shock sensors include a MAP (Manifold Absolute Pressure) sensor, an ADXL-acceleration sensor, a piezo (knock) sensor, a gyro-acceleration sensor, and so on.

The refrigerant cutoff valves 500 and 510 are respectively installed at the lines of the evaporator 300 at the sides of refrigerant inlet and outlet, i.e., the lines of the evaporator 300 connected to an expansion valve and a compressors, and cut off the flow of the refrigerant according to the signal value of the control unit 400.

That is, the refrigerant cutoff valves 500 and 510 have a structure such that a disk hi a body is rotated according to the input signal value to close a path, and employ a well-known manual or automatic type valve.

In the above-described gas safety device of a heating, ventilating, and air conditioning system for vehicles, when gas is leaked in the engine room after a starting switch of the vehicle is turned on, the gas sensor 200 installed at the air inlet 100 connecting the engine room and the inside of the vehicle senses the gas leakage, and outputs a corresponding signal value to the control unit 400. Further, when a shock is applied to the vehicle, the shock sensor 600 senses the shock, and outputs a corresponding signal value to the control unit 400. In case that either one of the above two signal values is input to the control unit 400, the control unit 400 determines whether or not gas is leaked through the input signal value, and selectively operates the refrigerant cutoff valves 500 and 510 installed at the lines of the evaporator 300 at the sides of the refrigerant inlet and outlet, thus controlling the flow of the refrigerant.

The gas safety device may further include an alarming unit 700 for giving a gas leakage alarm in the vehicle or a display unit 800 for displaying a gas leakage state so that passengers in the vehicle can verify the signal value of the gas sensor 200.

Further, in the first and second embodiments, a gas discharging door for discharging flown-in gas to the outside may be provided in the air inlet 100.

### INDUSTRIAL APPLICABILITY

As apparent from the above description, the present invention provides a gas safety device of a heating, ventilating, and air conditioning system for vehicles, in which when a signal value from either a gas sensor installed at an air inlet connecting an engine room and the inside of a vehicle or a shock sensor installed in the vehicle is input to a control unit, the control unit determines whether or not gas is leaked through the input signal value, selectively operates a refrigerant cutoff valve installed at a line of an evaporator at the side of a refrigerant inlet, and thus controls the flow of a refrigerant. Thereby, in case that a combustible refrigerant gas is used, it is possible to prevent a gas explosion.

When the gas is leaked, the gas sensor senses the gas leakage, and an alarm unit or a display unit informs the gas leakage of a driver or passengers, thereby preventing an accident caused by the gas leakage.

Since the gas leakage is sensed or the gas flow is restricted, a combustible gas, which was not conventionally used due to danger of an explosion, can be used as the refrigerant.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A gas safety device of a heating, ventilating, and air conditioning system for vehicles, comprising:
a gas sensor installed at an air inlet connecting an engine room and the inside of a vehicle;
a shock sensor installed in the vehicle; and
at least one refrigerant cutoff valve installed at one or more of lines of an evaporator at the sides of refrigerant inlet and outlet for restricting the flow of a refrigerant by means of the operation of a control unit according to either of sensing signal values of the gas sensor and the shock sensor.

2. The gas safety device according to claim 1, further comprising either of an alarming unit for giving a gas leakage alarm in the vehicle and a display unit for displaying a gas leakage state so that passengers in the vehicle can verify the sensing signal value of the gas sensor provided at the air inlet.

3. A method for controlling a gas safety device of a heating, ventilating, and air conditioning system for vehicles, in which when either of sensing signal values of a gas sensor installed at an air inlet connecting an engine room and the inside of a vehicle and a shock sensor installed in the vehicle is input to a control unit, the control unit operates at least one refrigerant cutoff valve installed at one or more of lines of an evaporator at the sides of refrigerant inlet and outlet according to the input sensing signal to control the flow of a refrigerant.
